(19) United States
(12) Patent Application Publication
(10) Pub. No.: US 2011/0078693 A1
(43) Pub. Date: Mar. 31, 2011

(54) METHOD FOR REDUCING THE WAITING TIME WHEN WORK STEPS ARE EXECUTED FOR THE FIRST TIME

(76) Inventors: Antonius Ax, Effeltrich (DE); Detlef Becker, Mohrendorf (DE); Karlheinz Dorn, Kalchreuth (DE); Subrata Sinha, Erlangen (DE)

(21) Appl. No.: 12/891,011

(22) Filed: Sep. 27, 2010

(30) Foreign Application Priority Data
Sep. 28, 2009 (DE) 10 2009 043 253.1

(51) Int. Cl. G06F 9/48

(52) U.S. Cl. 718/103; 718/100

(57) ABSTRACT

A method and a medical computer system for executing the method are disclosed for reducing the waiting time for at least one user of the computer system when they first execute at least one work step in the computer system. The method includes pre-starting a process which is not yet assigned to a user, and loading the services into the process, which the applications initiated by a user to execute the at least one work step are very likely to call without the user already being assigned to the process.

### PRIORITY STATEMENT

The present application hereby claims priority under 35 U.S.C. §119 on German patent application number DE 10 2009 043 253.1 filed Sep. 28, 2009, the entire contents of which are hereby incorporated herein by reference.

### FIELD

At least one embodiment of the invention generally relates to a method and/or to an associated facility for reducing the waiting time when work steps are executed for the first time in computer systems based on an expandable medical software platform.

### BACKGROUND

The creation of medical results consists of a sequence of work steps executed by different users at different times on different workstations, e.g. patient admission (reception, secretary), patient examination (scanner, medical technician), image post-processing (scanner, medical technician) diagnosis creation (radiology viewing room, radiologist)).

The actual steps, their sequence of execution and the software applications used in the individual steps depend on the best practice process of the service operator. The role and the steps actually able to be implemented in the results process likewise depends on the service operator guidelines. Both the process and also the software applications available change over the lifetime of a product at the clinical customer.

Since the distributed results process operates on the same data the use of a client/server topology is recommended, with all data being held on a central server and the user only connecting to the central server via thin-client or rich-client software in order to work with the data.

Each time a user makes a connection from their client to the server for the first time, a set of software applications is started for this user which this user will then use. In such cases the actual set of applications depends on which patient examinations have been undertaken, which clinical questions are to be answered and why this user is connecting at this time—he may also wish to view ad-hoc data for a previous case. The user can only work with the software once the appropriate applications have been started for him on the server. The user's work is thus delayed the first time that he makes the connection from a client to the server. In the medical environment such a delay can be a hindrance in emergency situations.

With Web applications an approach is generally selected in which the applications are hosted in the same process for all users and applications can also serve a number of users in parallel.

Pure Web applications can only be used to a restricted extent within the framework of medical image processing for diagnosis creation, since they exhibit a higher latency/delay for user interactions and can also offer only restricted user interface functionality.

Process sharing on the server machine between users is also critical since a faulty process simultaneously hinders or even destroys the work of a number of users. Thus a separate process per user is recommended. Attempts are also made to avoid multi-document applications for medical image processing, since otherwise an application has to meet high demands in order to avoid data from different patients (multiple documents) being inadvertently confused in the application. For performance reasons so-called “stateful” services are used in medical processing.

### SUMMARY

In at least one embodiment of the present invention, a process is designed to be flexible and to minimize delays in the initial execution of an application.

In at least one embodiment, a method and/or also a facility is disclosed. Advantageous embodiments of the method as well as of the facility are the subject matter of the dependent claims or can be taken from the subsequent description as well as the exemplary embodiments.

One aspect of at least one embodiment of the invention is a method for reducing the waiting time for at least one user of a preferably medical computer system during the latter's execution of at least one operating step in the computer system, comprising:
Pre-starting a process which is not yet assigned to any user,
Loading the services into this process which are very likely to call the applications initiated by a user for executing the at least one operating step, without the user already being assigned this process.

If this process has been assigned to an actual user then the applications of the user necessary for further work steps are loaded into this process and executed.

At least one further process can be pre-started with a lower priority than the already pre-started process as soon as the already pre-started process has been assigned to an actual user. This can be repeated. The number of processes to be pre-started is configurable in this case. For example in the case of 12 users a maximum of 12 processes is pre-started. In other words, if a single user has been assigned, two processes are pre-started. If two users have been assigned then two processes are again pre-started, meaning that a total of four processes are running. This can be repeated iteratively until a maximum 12 processes are running for twelve users. For a 13th user no pre-started process would be available any longer. The number of users as well as the number of processes pre-started simultaneously are configurable as required in this case.

Furthermore at least one further application of the at least one work step can be initiated which is allocated to the same process in which the initial services able to be called up have been loaded or to another separate pre-started process.

As soon as the other separate pre-started process is assigned to a natural user, a further instance of the same application in a further separate, pre-started process with a lower priority than that of the other separate previously assigned and pre-started process can be made available for execution. This can be repeated. This method in respect of separately pre-started processes or processes to the pre-started is especially useful for so-called non-communal applications as is explained in greater detail in the example embodiment described below.

As already partly described above, the pre-starting of a process can be initiated with the aid of a static configuration. A pre-starting of a process with the aid of a dynamic configuration based on at least one said work step is also conceivable. Furthermore a pre-starting of a process with the aid of a heuristic configuration based on an evaluation of the frequency of the applications previously initiated by a user has proved useful.

A further aspect of at least one embodiment of the invention is a medical computer system, having a device for executing the above-mentioned method for reducing the waiting time for at least one user of the computer system during their first execution of at least one work step in the computer system.

### BRIEF DESCRIPTION OF THE DRAWINGS

Further details, advantages and developments of the invention emerge from the subsequent description of example embodiments in conjunction with the drawings. In the drawings:

FIG. 1 shows an example of an architecture of a distributed computer system which is used for example in a hospital or in a medical practice, is designed for an embodiment of the inventive method, and

FIG. 2 shows an example of an execution sequence of an embodiment of the inventive method.

### DETAILED DESCRIPTION OF THE EXAMPLE EMBODIMENTS

Various example embodiments will now be described more fully with reference to the accompanying drawings in which only some example embodiments are shown. Specific structural and functional details disclosed herein are merely representative for purposes of describing example embodiments. The present invention, however, may be embodied in many alternate forms and should not be construed as limited to only the example embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the present invention to the particular forms disclosed. On the contrary, example embodiments are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

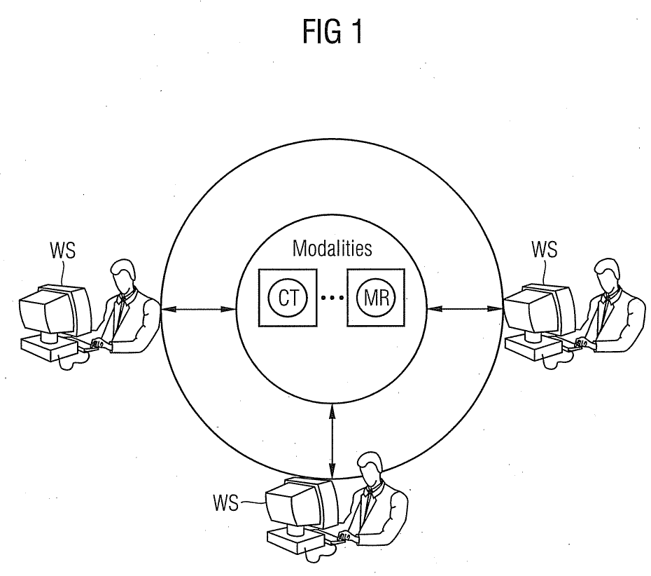

In detail the inner ring in FIG. 1 shows the server side of the distributed computer system. Included therein are medical modalities such as CT and MR devices for example. These execute operating steps of which the object is to produce DICOM images of patient organs of interest. DICOM (Digital Imaging and Communications in Medicine) is widely used in medicine as an open standard for exchanging information.

After the images have been recorded they will be made available to users of the indicated outer ring in FIG. 1—which corresponds to the client side of the computer system—at workstations WS such that only a view of the images processed on the server side is provided. Medical applications are generally subdivided into a so-called business logic, i.e. the processing part of the application, and a so-called presentation logic, i.e. the presenting or visualizing part of the application. The business logic generally runs on the server side, while the presentation logic runs on the client side.

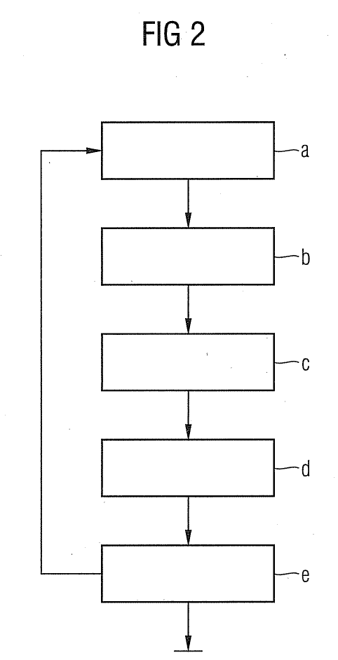

Normally services which are called up or used by the applications are loaded dynamically into a process, as typically occurs in the Windows Process Activation Service from Microsoft. Delays are here essentially caused by the starting of new processes, the loading of assemblies (translated program classes) and generation of the object instances for the software applications needed. If a user starts the software on the client machine or computer, this software will initially appear with a defined set of functions. These can be both applications for viewing and searching for medical data or work lists (e.g. data/work list browsers) within the framework of medical image processing software and also the opportunity of observing the status of background activities, e.g. print jobs, data imports, data exports etc.). To achieve a reduction in the waiting time for users during initial operation, the following mechanisms—as indicated in a sequence in FIG. 2 with steps a to e—are introduced on the server.
In step a execution of all applications which the user uses during the course of his session is started in the same user-specific process. Thus the business logic of the application is realized as a service and execution of this service is started in a user-specific service host.
In step b a configurable number of processes is pre-started with server functionality to search for medical data and to check the status of background activities (after the server start). These processes are initially not assigned to any user.
Step c: If a user now starts his software or application on a client then this software can link itself directly to a pre-started process in which the initial server-side functions for the client application are already present.
Step d: The server-side pre-started functionalities now also execute the user-dependent part of their initialization (if such components are present in a service). An example for such a user-specific initialization step is the reading of user-specific application options (e.g. filter criteria and sort sequence in the data browser).
Step e: Whenever a new user has had a pre-started process allocated to them, a new process with the selected server functionality is again (pre-)started by the system. This pre-start is executed with a lower operating system priority in order not to adversely affect the performance for interactive users of the system.

By use of the invention, it is possible to reduce the initial waiting time on starting the software by the time needed to start a new process, to initialize its infrastructure so that it is in a position to load services dynamically and to load and start the set of initially needed services. This means that a runtime environment is already set up on the server side which can be allocated to a new user without further delay.

The introduction of a user-specific process also has the advantage that the life cycle of this process is linked to the user session, i.e. when the user ends the software on the client side the associated process can also be ended on the server side. This avoids processes running for a long time over a number of user sessions.

During the further sequence of the work the user will handle further tasks with the software (e.g. undertake a cardio-vascular analysis or evaluate a virtual colonoscopy) which require specific applications which are not contained in the pre-started set of services.

The starting of the new services is also speeded up by the invention since the process already exists for this user into which the new application must be loaded. In addition an appropriate number of assemblies is already loaded into this process (through the loading of the server functionality which is initially common to all clients). This aspect is a side effect of the medical platform in which all applications are constructed on a predominantly communal set of assemblies. Thus only the loading of the missing assembles and the setting up of the application objects remains to be dealt with, whereby a (reduced) delay in the initial use of these additional applications is brought about.

At the same time the loading of the applications into a process minimizes the overall memory use for all these applications by comparison with starting the applications in respective different processes in each case. This supports a better scalability of the server hardware for more users. If one were to pre-start these specific applications in the same way as the server functionality which is initially common to each client, then under some circumstances one would pre-start too many application instances, since not every client needs all applications in each session. Thus resources would be wasted on the server and additional load would be generated unnecessarily.

The pre-starting of such specific applications must therefore be subject to another strategy:
Specific applications which not every user needs in every session will be pre-started in a separate process in each case.
Whenever a user wishes to use a specific application, he can be allocated the application on the server side in the separately pre-started process.
Each time that a user has been allocated a specific application, the system starts a new instance of the application on the server side in a separate process. The result of this is that an instance of each non-communal application is pre-started on the server side, with this able to be allocated to a user if necessary. By means of this process the waiting time for new users on first use can be reduced to a minimum even for non-communal applications (allocation time and user-specific initialization time).

In the case of operating steps in which more than one non-communal application is used, a balancing can be undertaken with the above two methods:
Since in one work step the same data is processed in turn in the different applications, it is expedient (from the point of view of performance) to load this data only once into a process, where it can then be shared by all applications in turn.

Were the applications to run in different processes (where possible even on different server machines), then the result data of the one application would have to be copied from the one process into the subsequent application in another process. Such copying actions can be executed much more efficiently within the same process.

Thus a balancing in relation to the shortest overall duration of a work step is possible, by
pre-starting further non-communal applications directly with the initial server functions in a process (while accepting that this user might not be able to use this functionality in their session, but the resources are still linked despite this). This is recommended for applications which exchange larger volumes of data with each other and with a sufficiently high probability that the user will also carry out the corresponding work steps.
pre-starting further non-communal applications in separate processes in order to minimize the waste of unnecessarily pre-started applications. This approach should be selected for applications which only exchange small volumes of data or for which the probability of use for each user is rather low.
reloading further non-communal applications into the user-specific process if needed. Although this does not reduce the initial waiting time to the same extent as the two alternative previously presented, it does still save on starting a new process and loading many assemblies while simultaneously ensuring that no resources have been linked unnecessarily beforehand. The efficient exchange of data between the applications with the same process likewise reduces the overall duration of an operating step. The mechanism presented here allows all three variants in system-specific adaptable combinations.

Options for optimum configuration of a system:
Static configuration (factory setting): If the system has a clearly defined scope of performance at the point of manufacture (e.g. an ultrasound scanner), then the best runtime environment can already be defined by the manufacturer and also given to the system life cycle controller as a configuration. (The system life cycle controller is the service which starts, monitors and ends all the necessary services on a server).
Dynamic configuration: As well as the static configuration of communal services which is initially pre-started for each user, a set of applications can also be dynamically pre-started at runtime. The determination of the services which are to be usefully started dynamically at a particular point is then transferred to a scheduling system which:
knows which role in a department carries out which work steps.
knows which work steps are to be carried out at all.
knows which user has currently registered in the system in which role and is processing his work lists.

Since the work scheduler normally starts the application(s) needed for the user if the user has selected an actual work step from his work list, this work scheduler can also preemptively pre-start the applications which correspond to the work steps in the work list of the user. These applications can now also simply be pre-started in the user-specific process since the work steps are uniquely assigned to a list of one or more users. While the user is looking at his work list to select a work step, the system can also already be pre-starting the possible applications relevant for him.
Heuristic configuration: The most frequently used applications have been determined from the usage profile of previous sections and can thus also the automatically pre-started by the system at the next start (without making a static configurations or dynamic configuration necessary as a result of work steps actually to be carried out).

The static configuration quickly makes the communal functionality available to a new user and the dynamic configuration has enhanced the user-specific process by the applications which this user could also use as a result of the contents of his work list. Thus the non-communal applications are also rapidly made available to the user. A reduction in the waiting time on first execution of non-planned work steps is also possible by means of the heuristic configuration if these deviations from planned work only occur frequently enough.

For a medical software platform on the basis of which a plurality of different medical products is to be built (scanners, information systems, knowledge management systems, archive systems and image post processing systems), adaptability of the pre-start strategies is essential. This is based on the fact that the systems can be used in different work sequences of the customer and partly can also be adapted to the changing requirements and work sequences of the customer. Invariant system characteristics for pre-start can be defined in each case by means of static configuration while the dynamic configuration mechanisms adapt the customer-specific rules (which role/which user executes which applications) and work sequences.

The patent claims filed with the application are formulation proposals without prejudice for obtaining more extensive patent protection. The applicant reserves the right to claim even further combinations of features previously disclosed only in the description and/or drawings.

The example embodiment or each example embodiment should not be understood as a restriction of the invention. Rather, numerous variations and modifications are possible in the context of the present disclosure, in particular those variants and combinations which can be inferred by the person skilled in the art with regard to achieving the object for example by combination or modification of individual features or elements or method steps that are described in connection with the general or specific part of the description and are contained in the claims and/or the drawings, and, by way of combineable features, lead to a new subject matter or to new method steps or sequences of method steps, including insofar as they concern production, testing and operating methods.

References back that are used in dependent claims indicate the further embodiment of the subject matter of the main claim by way of the features of the respective dependent claim; they should not be understood as dispensing with obtaining independent protection of the subject matter for the combinations of features in the referred-back dependent claims. Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form separate and independent inventions, the applicant reserves the right to make them the subject matter of independent claims or divisional declarations. They may furthermore also contain independent inventions which have a configuration that is independent of the subject matters of the preceding dependent claims.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program, computer readable medium and computer program product. For example, of the aforementioned methods may be embodied in the form of a system or device, including, but not limited to, any of the structure for performing the methodology illustrated in the drawings.

Even further, any of the aforementioned methods may be embodied in the form of a program. The program may be stored on a computer readable medium and is adapted to perform any one of the aforementioned methods when run on a computer device (a device including a processor). Thus, the storage medium or computer readable medium, is adapted to store information and is adapted to interact with a data processing facility or computer device to execute the program of any of the above mentioned embodiments and/or to perform the method of any of the above mentioned embodiments.

The computer readable medium or storage medium may be a built-in medium installed inside a computer device main body or a removable medium arranged so that it can be separated from the computer device main body. Examples of the built-in medium include, but are not limited to, rewriteable non-volatile memories, such as ROMs and flash memories, and hard disks. Examples of the removable medium include, but are not limited to, optical storage media such as CD-ROMs and DVDs; magneto-optical storage media, such as MOs; magnetism storage media, including but not limited to floppy disks (trademark), cassette tapes, and removable hard disks; media with a built-in rewriteable non-volatile memory, including but not limited to memory cards; and media with a built-in ROM, including but not limited to ROM cassettes; etc. Furthermore, various information regarding stored images, for example, property information, may be stored in any other form, or it may be provided in other ways.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for reducing waiting time for a least one user of a computer system during their first execution of a least one work step in the computer system, the method comprising:
pre-starting a process which is not yet assigned to any user; and
loading services into the process which is highly likely to call applications initiated by a user for executing the at least one work step without the user already being assigned to the process.

2. The method as claimed in claim 1, wherein the computer system is a medical computer system.

3. The method as claimed in claim 1, wherein, when the process has been assigned to an actual user, then the applications of the user necessary for further work steps will be loaded into the process and executed.

4. The method as claimed in claim 1, wherein at least one further process with a relatively lower priority than the process already pre-started is pre-started, as soon as the pre-started process has been assigned to an actual user.

5. The method as claimed in claim 4, wherein the steps of claim 4 are repeated.

6. The method as claimed in claim 4, wherein at least one further application of the at least one work step is initiated which is allocated to the same process in which the initial callable services have been loaded or to another separate pre-started process.

7. The method as claimed in claim 6, wherein, as soon as the other separate, pre-started process is assigned to an actual user, a further instance of the same application is made available in a further separate pre-started process with a relatively lower priority than the other separate previously assigned and pre-started process for execution.

8. The method as claimed in claim 7, wherein the steps of claim 7 are repeated.

9. The method as claimed in claim 1, wherein the pre-starting of a process is initiated with a static configuration.

10. The method as claimed in claim 1, wherein the pre-starting of a process is initiated with the help of a dynamic configuration based on at least one said work step.

11. The method as claimed in claim 1, wherein the pre-starting of a process is initiated with the aid of a heuristic configuration based on an evaluation of the frequency of the applications previously initiated by a user.

12. A medical computer system for executing a method for reducing wait time for at least one user of the computer system on their first execution of at least one work step in the computer system, the medical computer system comprising:
means for pre-starting a process which is not yet assigned to any user; and
means for loading services into the process, applications initiated by a user being very likely to call to execute the least one work step without the user already being assigned to the process.

13. The medical computer system as claimed in claim 12, wherein, when the process is assigned to an actual user, then the necessary applications of the user for further work steps are loadable into the process and are executable.

14. The medical computer system as claimed in claim 12, wherein at least one further process with a relatively lower priority than the already pre-started process is pre-startable as soon as the already pre-started process is assigned to an actual user.

15. The medical computer system as claimed in claim 14, wherein at least one further application of the at least one work step is initiatable which is allocatable to the same process in which the initially callable services are loaded or to another separate pre-started process.

16. The medical computer system as claimed in claim 15, wherein, as soon as the other separate, pre-started process is assigned to an actual user, a further instance of the same application is available for execution in a further separate, pre-started process with a relatively lower priority than that of the other separate, previously assigned and pre-started process.

17. The method as claimed in claim 5, wherein at least one further application of the at least one work step is initiated which is allocated to the same process in which the initial callable services have been loaded or to another separate pre-started process.

18. The method as claimed in claim 17, wherein, as soon as the other separate, pre-started process is assigned to an actual user, a further instance of the same application is made available in a further separate pre-started process with a relatively lower priority than the other separate previously assigned and pre-started process for execution.

19. The method as claimed in claim 18, wherein the steps of claim 18 are repeated.

20. The medical computer system as claimed in claim 13, wherein at least one further process with a relatively lower priority than the already pre-started process is pre-startable as soon as the already pre-started process is assigned to an actual user.

21. The medical computer system as claimed in claim 20, wherein at least one further application of the at least one work step is initiatable which is allocatable to the same process in which the initially callable services are loaded or to another separate pre-started process.

22. The medical computer system as claimed in claim 21, wherein, as soon as the other separate, pre-started process is assigned to an actual user, a further instance of the same application is available for execution in a further separate, pre-started process with a relatively lower priority than that of the other separate, previously assigned and pre-started process.
